(19) United States
(12) Patent Application Publication
(10) Pub. No.: US 2026/0048808 A1
(43) Pub. Date: Feb. 19, 2026

(54) ELECTRIC MOTORCYCLE AND FRAME ASSEMBLY FOR MOTORCYCLE

(71) Applicant: BOMBARDIER RECREATIONAL PRODUCTS INC., Valcourt (CA)

(72) Inventors: Magali BITSCH, Waterloo (CA); Francisco Javier BLANCO CANELA, Sherbrooke (CA); Christian LABBE, Magog (CA)

(21) Appl. No.: 19/301,711

(22) Filed: Aug. 15, 2025

Related U.S. Application Data
(60) Provisional application No. 63/683,865, filed on Aug. 16, 2024.

(51) Int. Cl. B62K 11/04; B62J 1/08; B62J 7/04; B62J 17/00

(52) U.S. Cl. CPC B62K 11/04; B62J 1/08; B62J 7/04; B62J 17/00

(57) ABSTRACT

A frame assembly for a motorcycle and a motorcycle. The motorcycle includes a front frame structure; a front wheel; a rear frame structure including a first half-frame and a second half-frame body connected to the front frame structure, the second half-frame body being laterally spaced from the first half-frame body; and a crossmember connected between a rear portion of the first half-frame and a rear portion of the second half-frame; a rear wheel; and a motor operatively connected to at least one of the front wheel and the rear wheel. The crossmember has mounting points for selectively connecting a plurality of vehicle components, the plurality of vehicle components including at least two of: a driver seat, a passenger seat, a rear fender, a seat cowl, and a taillight.

### CROSS-REFERENCE

The present application claims priority to U.S. Provisional Ser. No. 63/683,865, entitled “Electric Motorcycle and Frame Assembly for Motorcycle,” filed Aug. 16, 2024, the entirety of which is incorporated by reference herein.

### FIELD OF TECHNOLOGY

The present technology relates to electric motorcycle frames.

### BACKGROUND

Straddle seat vehicles, including motorcycles, all-terrain vehicles, and snowmobiles, are popular transport and recreational vehicles. As the move toward electrification of vehicles progresses, interest in electric versions of straddle seat vehicles, including electric motorcycles, increases.

Motorcycle frames are commonly made up of two welded metal space frame halves, which are joined with crossmembers. The frame halves are generally welded together with the crossmembers to provide a structurally sound connection. Welded space frames can have relatively broad fabrication tolerances however, complicating precision assembly of the welded space frames with other welded assemblies,

Many motorcycles have modular capabilities, allowing for example: different seat configurations (single driver seat or inclusion of a passenger seat), optional storage (such as saddle bags). This modularity requires specific mounting points to be provided on the frame, which in turn require additional components or connection points to be installed onto the frame.

There is therefore a desire for arrangements of motorcycles addressing at least some of the above-described disadvantages.

### SUMMARY

It is an object of the present technology to ameliorate at least some of the inconveniences present in the prior art.

According to one aspect of the present technology, there is provided a motorcycle including a front frame structure; a front wheel operatively connected to the front frame structure; a rear frame structure including a first half-frame body connected to the front frame structure; a second half-frame body connected to the front frame structure, the second half-frame body being laterally spaced from the first half-frame body; and a crossmember connected between a rear portion of the first half-frame and a rear portion of the second half-frame; a rear wheel operatively connected to at least one of the front frame structure and the rear frame structure; and a motor operatively connected to at least one of the front wheel and the rear wheel, the crossmember having mounting points for selectively connecting a plurality of vehicle components, the plurality of vehicle components including at least two of: a driver seat, a passenger seat, a rear fender, a seat cowl, and a taillight.

In some embodiments, the motorcycle further includes at least one of the driver seat and the passenger seat supported by the rear frame structure.

In some embodiments, the first half-frame body and the second half-frame body are welded space frames.

In some embodiments, the first half-frame body and the second half-frame body are formed from a first material; and the crossmember is formed from a second material different from the first material.

In some embodiments, the crossmember is formed from a flexible material.

In some embodiments, the crossmember is formed from a molded material.

In some embodiments, the crossmember is formed from a polymer material.

In some embodiments, the crossmember is formed from a plastic material.

In some embodiments, the crossmember is positioned and arranged to form a structural connection between the first and second half-frame bodies.

In some embodiments, the crossmember is further configured to selectively receive at least one of: at least one passenger seat handle, at least one saddle bag, and a top case.

In some embodiments, the motorcycle further includes a swingarm connected to at least one of the front frame structure and the rear frame structure; and the rear wheel is operatively connected to the swing arm.

In some embodiments, the motorcycle is an electric motorcycle comprising a battery pack; and the front frame structure is a battery housing of the battery pack.

In some embodiments, the motorcycle further includes a swingarm connected to at least one of the front frame structure and the rear frame structure; and the rear wheel is operatively connected to the swingarm.

In some embodiments, the motorcycle further includes an electric motor mounted on the swingarm, the electric motor being electrically connected to the battery pack, the electric motor being operatively connected to the rear wheel for driving the rear wheel during use.

According to another aspect of the present technology, there is provided a frame assembly for a motorcycle, the frame assembly including a front frame structure; and a rear frame structure including a first half-frame body connected to the front frame structure; a second half-frame body connected to the front frame structure, the second half-frame body being laterally spaced from the first half-frame body; and a multifunction crossmember connected between a rear portion of the first half-frame and a rear portion of the second half-frame; the multifunction crossmember having mounting points for selectively connecting a plurality of vehicle components, the plurality of vehicle components including at least two of: a driver seat, a passenger seat, a rear fender, a seat cowl, and a taillight.

In some embodiments, the first half-frame body and the second half-frame body are welded space frames.

In some embodiments, the first half-frame body and the second half-frame body are formed from a first material; and the crossmember is formed from a second material different from the first material.

In some embodiments, the crossmember is formed from a flexible material.

In some embodiments, the crossmember is formed from a molded material.

In some embodiments, the crossmember is formed from a polymer material.

In some embodiments, the crossmember is formed from a plastic material.

In some embodiments, the crossmember is positioned and arranged to form a structural connection between the first and second half-frame bodies.

In some embodiments, the crossmember is further configured to selectively receive at least one of: at least one passenger seat handle, at least one saddle bag, and a top case.

For the purposes of the present application, terms related to spatial orientation such as forward, rearward, front, rear, upper, lower, left, and right, are as they would normally be understood by a driver of the vehicle sitting thereon in a normal driving position with the vehicle being upright and steered in a straight-ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein. The phrase “at least one of A and B” should be understood to mean “only A, only B, or both A and B”.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a motorcycle according to non-limiting embodiments of the present technology;

FIG. 2 is a top, rear, right side perspective, partially exploded view of the motorcycle of FIG. 1, with fairings having been removed;

FIG. 3 is a top, rear, right side perspective view of a frame, wheels, suspension assemblies, and a steering assembly of the motorcycle of FIG. 1;

FIG. 4 is a top, rear, right side perspective view of the motorcycle portions of FIG. 3, with a crossmember having been removed;

FIG. 5 is a top, rear, right side perspective view of the crossmember of the frame of the motorcycle of FIG. 1;

FIG. 6 is a top plan view of the crossmember of FIG. 5;

FIG. 7 is a bottom plan view of the crossmember of FIG. 5;

FIG. 8 is a top, front, right side perspective view of a rear frame structure of the motorcycle of FIG. 1, illustrated with components supported thereby;

FIG. 9 is a top, rear, right side perspective view of the rear frame structure and components of FIG. 8; and

FIG. 10 is a top, rear, right side perspective view of the rear frame structure of the motorcycle of FIG. 1, illustrated supporting saddle bags.

It should be noted that, unless otherwise explicitly specified herein, the drawings are not necessarily to scale.

### DETAILED DESCRIPTION

The present technology will be described herein with respect to electric motorcycles, specifically a two-wheeled electric motorcycle 100. While the motorcycle 100 illustrated herein is a trail or dual sport style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

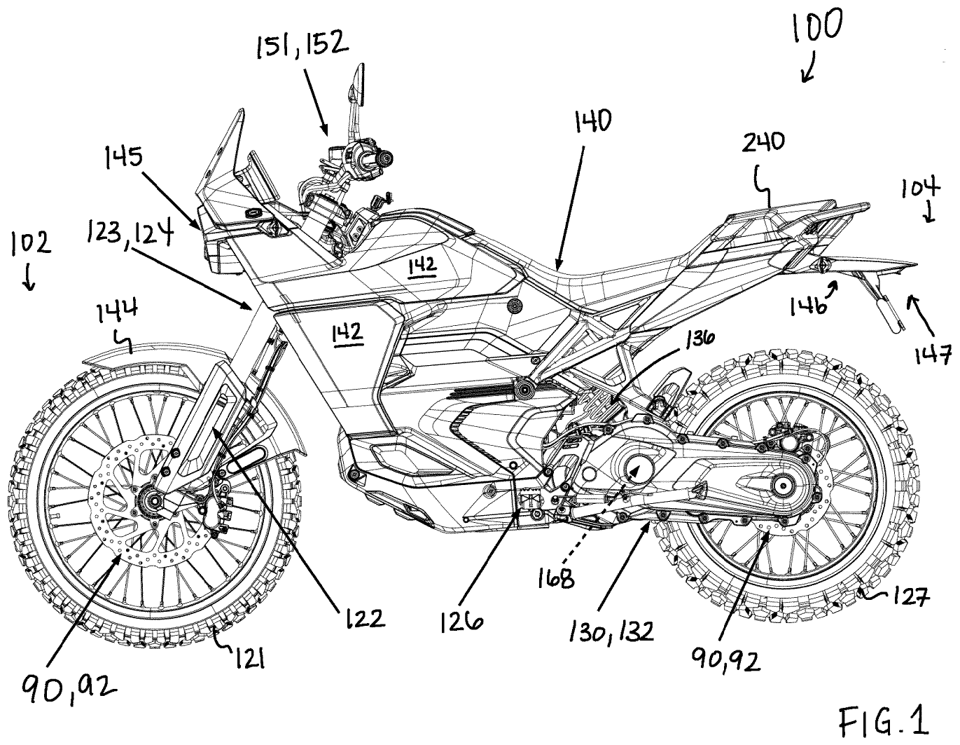

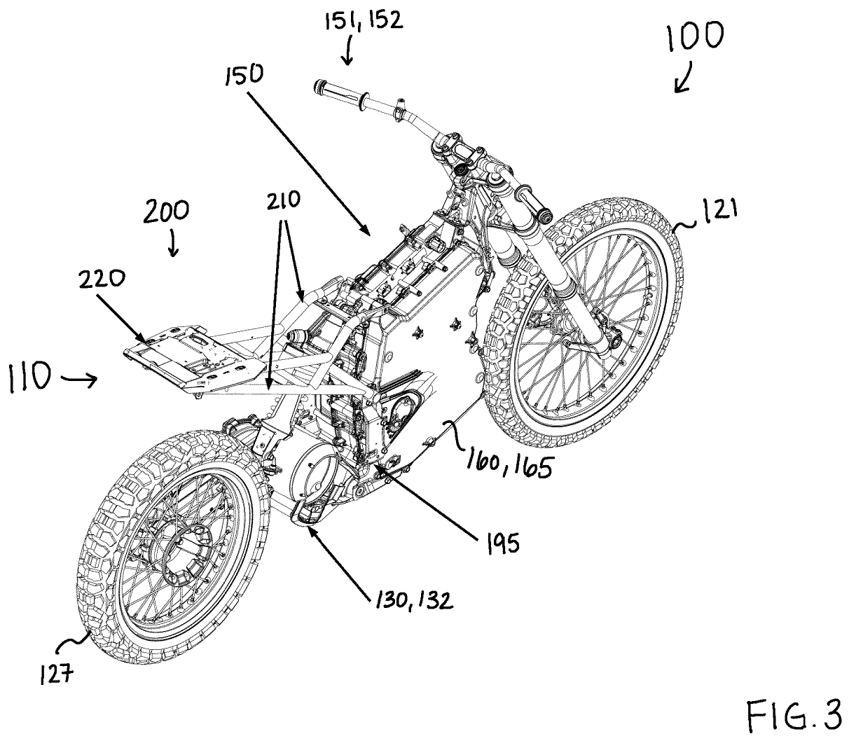

With reference to FIGS. 1 to 3, the electric motorcycle 100, also referred to herein as the vehicle 100, has a front end 102, a rear end 104, and a centerplane defined consistently with the forward travel direction of the vehicle 100. The vehicle 100 includes a front wheel 121 and a rear wheel 127. The front wheel 121 and the rear wheel 127 each have a tire secured thereto. The front wheel 121 and the rear wheel 127 are centered with respect to the longitudinal centerplane.

The vehicle 100 includes an electronic powerpack 150 for powering the vehicle 100. The powerpack 150 includes a battery pack 160, a charger (not shown), and an inverter (not shown). Also referred to as an energy storage system (ESS) or battery energy storage system (BESS), the battery pack 160 includes a battery pack housing 165, referred to herein as the housing 165. The battery pack 160 is arranged in the vehicle 100 such that the battery pack 160 and the battery pack housing 165 are disposed longitudinally between the front wheel 121 and the rear wheel 127. A top most point of the battery pack 160 and the battery pack housing 165 are vertically higher than the front wheel 121 and the rear wheel 127. A bottom most point of the battery pack 160 and the battery pack housing 165 are vertically lower than a rotation axis of the front wheel 121 and a rotation axis of the rear wheel 127.

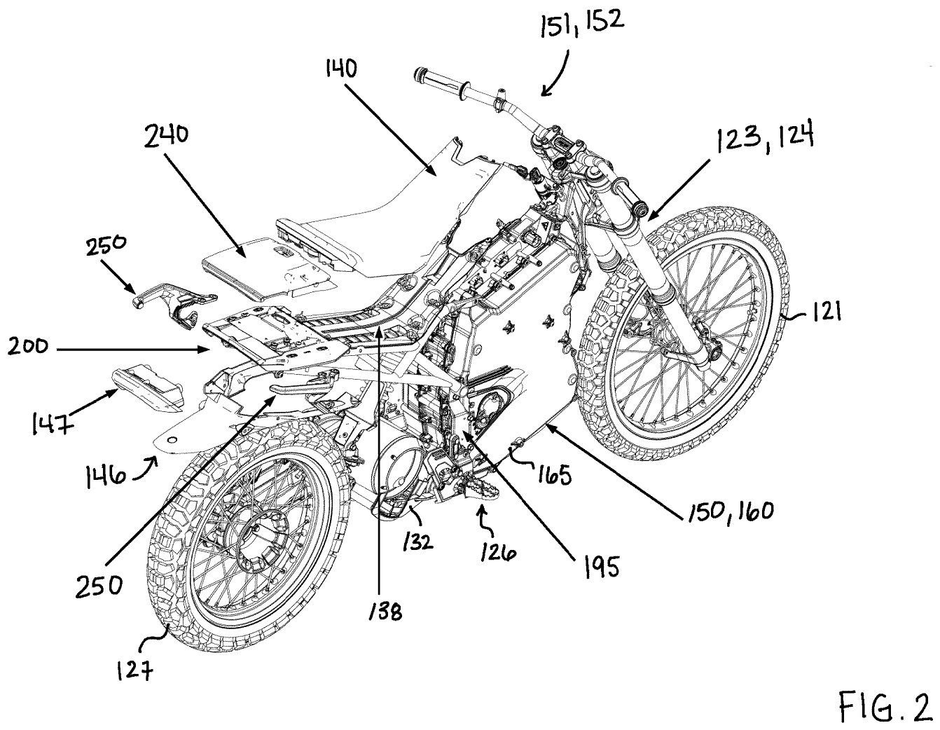

The vehicle 100 includes a frame 110 providing the central structure of the vehicle 100. By the present technology, the frame 110 is formed from a front frame structure and a rear frame structure 200 connected thereto. In the illustrated embodiment, the battery pack housing 165 forms the front frame structure of the frame 110. The rear frame structure 200, illustrated in FIG. 2, is connected to a rear portion of the battery housing 165. The rear frame structure 200 is described in more detail below.

The front wheel 121 is connected to the frame 110 by a front suspension assembly 123, the front wheel 121 being rotationally connected to the front suspension assembly 123. The front suspension assembly 123 includes a front fork assembly 124 for supporting the front end 102 of the vehicle 100. The front fork assembly 124 includes a pair of front shocks 122, with the front wheel 121 connected to a bottom portion of the pair of front shocks 122.

The vehicle 100 includes a handlebar assembly 152 operatively connected to the front fork assembly 124. The handlebar assembly 152 forms a portion of a steering assembly 151 and is used by the rider to turn the front wheel 121, via the front fork assembly 124, to steer the vehicle 100. A twist-grip throttle (not shown) is operatively connected on the right side of the handlebar assembly 152 for controlling vehicle speed. It is contemplated that the twist-grip throttle could be replaced by a thumb throttle lever or some other type of throttle input device. The twist-grip throttle could be disposed on the left side of the handlebar assembly 152 in some embodiments. The handlebar assembly 152 also includes a brake lever (not shown) on a right side for activating the brake assemblies 90.

The vehicle 100 further includes an electric motor 168 for driving the vehicle 100, specifically the rear wheel 127. The vehicle 100 includes a swing arm 132, with the rear wheel 127 being rotationally connected to the swing arm 132. The motor 168 is disposed in the swing arm 132 in the present embodiment. It is contemplated that the motor 168 could be differently arranged in some embodiments. Electric power is provided to the motor 168 by the electronic powerpack 150, the motor 168 being operatively connected to the battery pack 160. The motor 168 drives the rear wheel 127 via a transmission assembly (not shown) disposed in the swing arm 132. In the present embodiment, the motor 168 is a three-phase electric motor 168. It is contemplated that different types of motors could be used in some embodiments.

Returning to FIG. 1, the vehicle 100 includes a straddle seat 140 disposed along the longitudinal centerplane of the vehicle 100. Specifically, the vehicle 100 includes a seat frame 138 connected to the frame 110. The straddle seat 140 is connected to and supported by the frame 110. In the illustrated implementation, the straddle seat 140 is intended to accommodate a single adult-sized rider, i.e. the driver. As is described in further detail below, the vehicle 100 also includes a passenger seat 240, disposed rearward of the passenger seat 140 and supported by the rear frame structure 200.

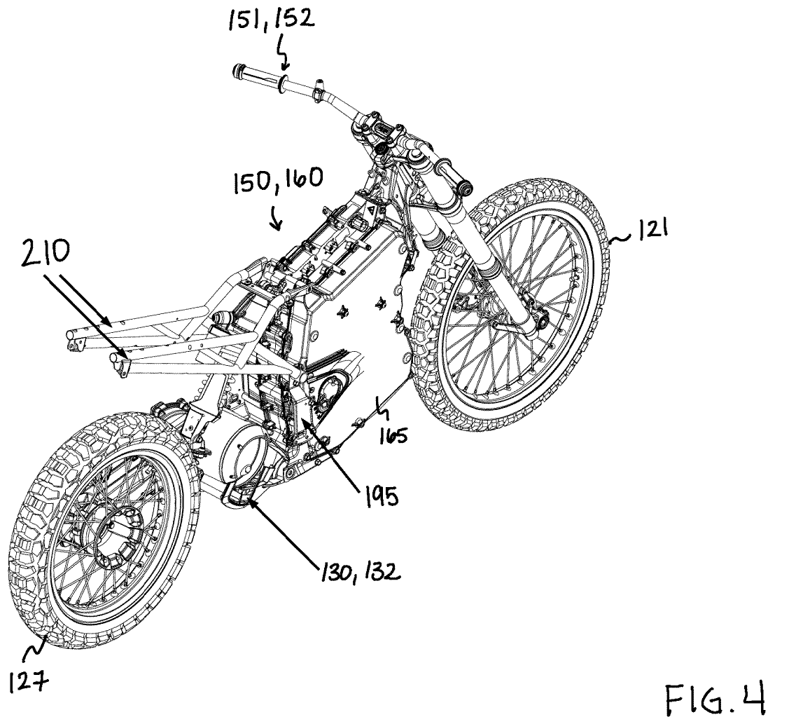

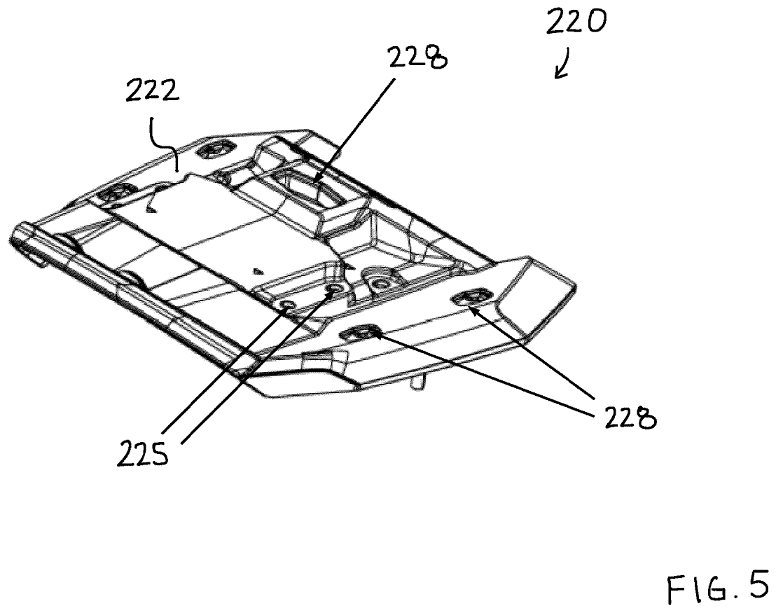

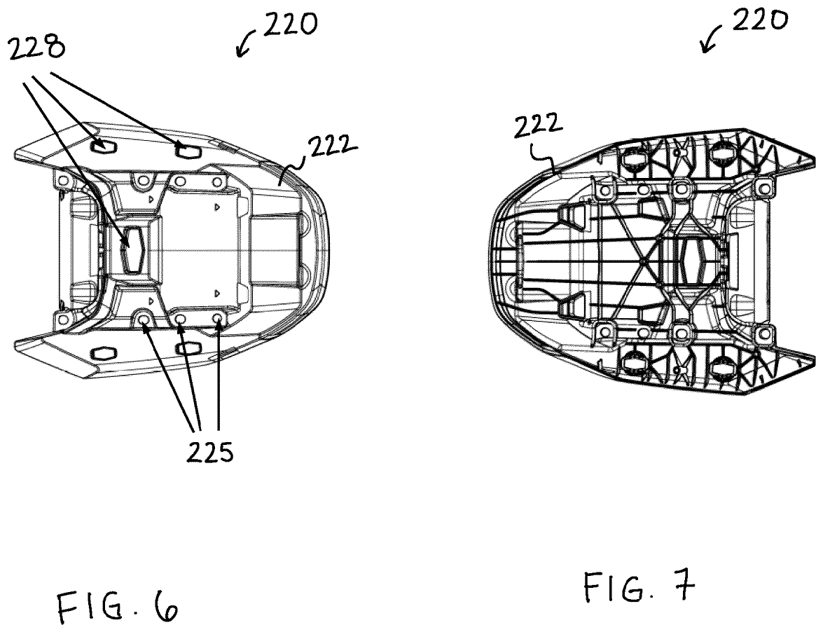

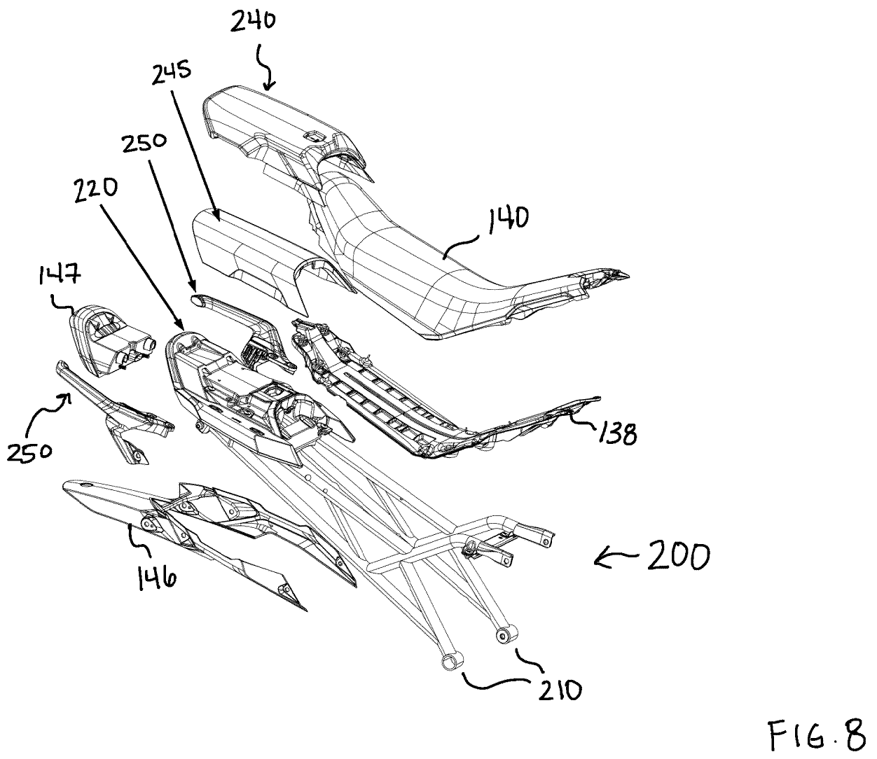

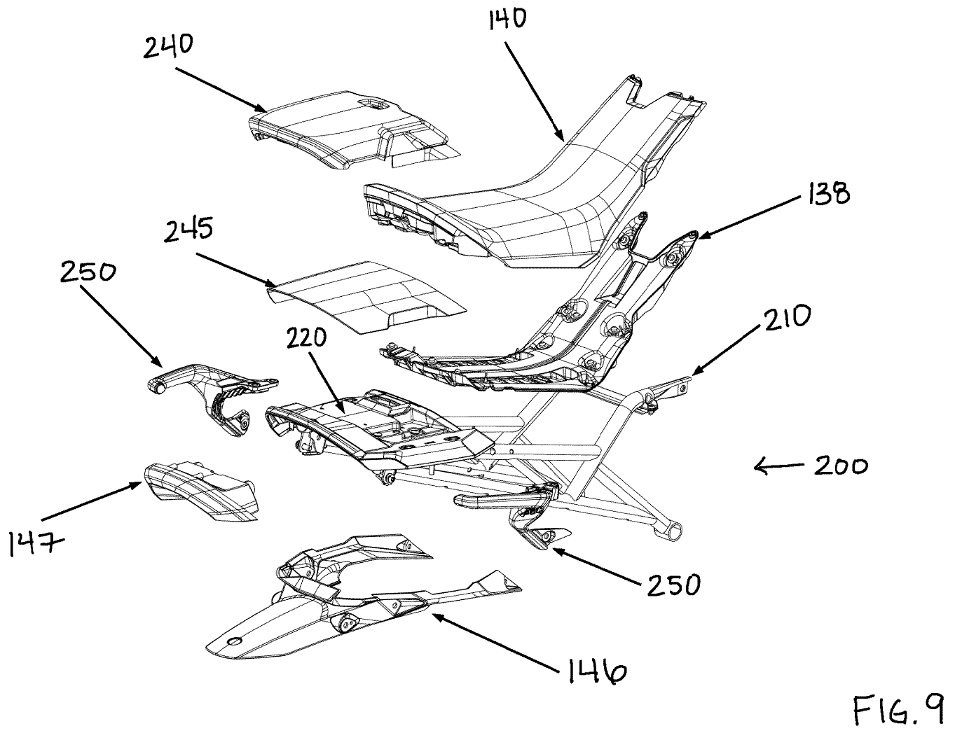

The vehicle 100 also includes a rear suspension assembly 130. The rear suspension assembly 130 includes the swing arm 132 and a shock absorber 136. As is mentioned above, the motor 168 and the drivetrain connecting the motor 168 to the rear wheel 127 are disposed in the swing arm 132. The swing arm 132 is pivotally mounted at a front thereof to the battery pack 160, specifically via two brackets 195 fastened to the battery pack 160 (see FIGS. 2 to 4). The rear wheel 127 is rotatably mounted to the rear end of the swing arm 132 which extends on a left side of the rear wheel 127. The shock absorber 136 is connected between the swing arm 132 and the frame 110. It is contemplated that the relative arrangement of the shock absorber 136 and the rear wheel 127 to the swing arm 132 could vary in different embodiments.

The vehicle 100 further includes a plurality of body panels 142 for forming the body of the vehicle 100, illustrated in FIG. 1. The body panels 142 are connected to and supported by the frame 110 and/or the rear suspension assembly 136. The body panels 142 enclose and protect some internal components of the vehicle 100 such as a powerpack 150. The vehicle 100 also includes a front fender 144 disposed at the front of the vehicle 100 and extending partially over the front wheel 121. The vehicle 100 includes front headlights 145 attached to the front fork assembly 124 and electrically connected to the battery pack 160. Rearward of the seat 140, the vehicle 100 also has rear fender panels 146 extending at least partially over rear wheel 127 and supporting the vehicle license plate. The vehicle 100 also has rear braking and indicator lights 147 supported by the rear panels 146 and electrically connected to the battery pack 150. As is described in more detail below, the rear fender panels 146 are supported by the rear frame structure 200.

Depending on the particular embodiment, especially between different motorcycle types (trail-style motorcycle or street-style motorcycle for example), the body panels 142 and the fenders 144, 146 could be different in shape and number. For example, some embodiments of the vehicle 100 could include a mud flap connected to a rear edge of one of the body panels 142. It is further contemplated that one or both of the fenders 144 and rear panels 146 could be omitted in some cases.

As is seen in FIG. 1, each of the front wheel 121 and the rear wheel 127 is provided with a brake assembly 90. The brake assemblies 90 of the wheels 121, 127, along with the brake pedal (not shown), form part of a brake system 92. Each brake assembly 90 is a disc-type brake mounted onto the spindle of the respective wheel 121 or 127. Other types of brakes are contemplated. The brake pedal, as well as a brake lever (not shown) disposed on the handlebar 152, are operatively connected to the brake assemblies 90 provided on each of the front wheel 121 and the rear wheel 127. The brake system 92 further includes a regenerative braking system (not shown) that uses the electric motor 168 as a generator to charge battery cells of the battery pack 160 while slowing the vehicle 100.

A driver footrest 126 is disposed on either side of the vehicle 100 and vertically lower than the straddle seat 140 to support the driver's feet. The driver footrests 126 are connected to the brackets 195. It is contemplated that the footrests 126 could be connected to different components in some embodiments. It is contemplated that the footrests 126 could be implemented in various forms other than those illustrated, including but not limited to pegs and footboards. It is contemplated that the vehicle 100 could also be provided with one or more passenger footrests disposed rearward of the driver footrest 126 on each side of the vehicle 100, for supporting a passenger's feet. A brake pedal (not shown) is connected to the right driver footrest 126 for braking the vehicle 100. The brake pedal is disposed forward of the right driver footrest 126 such that the driver can actuate the brake pedal 128 with a front portion of the right foot while a rear portion of the right foot remains on the right driver footrest 126.

It is contemplated that the vehicle 100 could include a variety of different features excluded from discussion here, including but not limited to: a windscreen, radio and/or navigational systems.

With reference to FIGS. 2 to 4, the rear frame structure 200 is connected to the battery housing 165 to form a frame assembly 110 for a motorcycle, shown in the present illustrations as installed in the motorcycle 100. The rear frame structure 200 includes a left half-frame body 210 and a right half-frame body 210 laterally spaced from the left half-frame body 210. The half-frame bodies 210 are welded space frames 210. It is contemplated that the specific shape and size of frames 210 could vary in different embodiments.

By the present technology, the rear frame structure 200 also includes a crossmember 220 for connecting together the half-frame bodies 210. The crossmember 220 is illustrated in isolation in FIGS. 5 to 7. The crossmember 220 is positioned and arranged to form a structural connection between the two half-frame bodies 210. Specifically, the crossmember 220 is connected between rear portions of the half-frame bodies 210, opposite the connection of the half-bodies 210 to the battery housing 165.

The crossmember 220 has a crossmember body 222 which is formed from a flexible material. The crossmember body 222 is formed by molding, although different fabrication techniques are contemplated. In the present embodiment, the crossmember 220, and more specifically the crossmember body 222, is formed from a polymer material, specifically a plastic material. Different materials are contemplated. The half-frame bodies 210 are formed from a different material than the crossmember 220. In the present embodiment, the half-frame bodies 210 are formed from a rigid material, specifically steel. Different material compositions for the half-frame members 210 are also contemplated.

The crossmember 220 has mounting points for selectively connecting a plurality of vehicle components to the vehicle 100. The crossmember body 222 has a plurality of through-holes 225 defined therein, to permit fasteners to be disposed through the crossmember 220 to connect various components or accessories. The crossmember body 222 also has a plurality of anchor apertures 228 defined therein to permit the connection of accessories or components having anchors to the crossmember 220. The particular number, size, and shape of apertures or holes defined in the crossmember body 222 could vary in different embodiments.

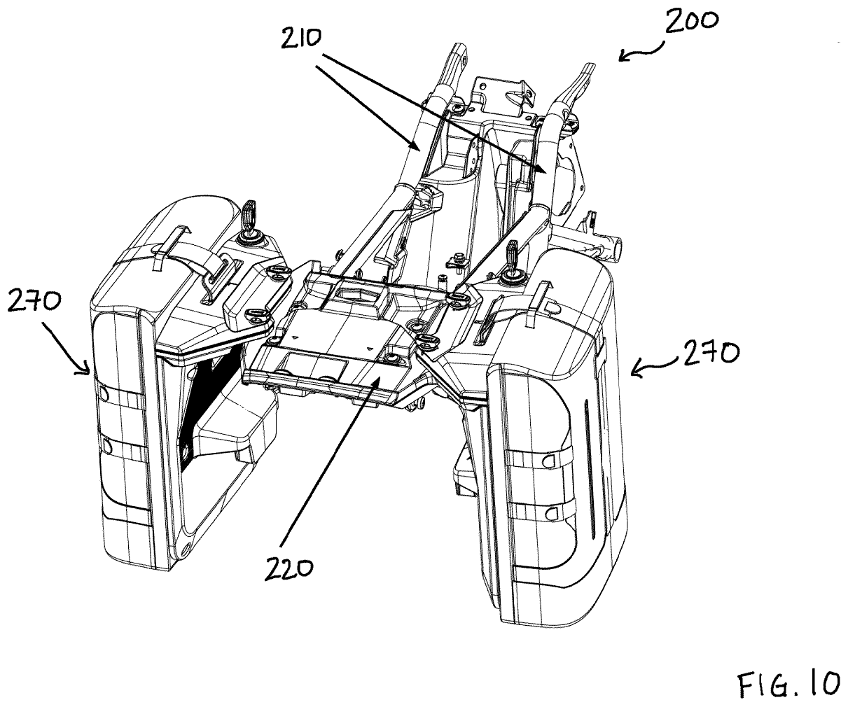

With additional reference to FIGS. 8 and 9, the crossmember 220 is configured to support multiple vehicle components, including the driver seat 140, the passenger seat 240, the rear fender 146, a seat cowl 245, and the taillight 147. The seat cowl 245 is configured to be connected rearward of the driver seat 140 when the passenger seat 240 is omitted from the vehicle 100. Rather than requiring mounts to be welded to the half-frame bodies 210, or holes cut therein, the crossmember 220 is molded into shape to receive a plurality of vehicle components. In some embodiments, the crossmember 220 is further configured to selectively receive one or two passenger seat handles 250.

With additional reference to FIG. 10, the crossmember 220 is further configured to selectively receive one or more saddle bags 270. It is further contemplated that the crossmember 220 could be configured to receive and support a top case (not shown).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A motorcycle comprising:
a front frame structure;
a front wheel operatively connected to the front frame structure;
a rear frame structure comprising:
a first half-frame body connected to the front frame structure;
a second half-frame body connected to the front frame structure, the second half-frame body being laterally spaced from the first half-frame body; and
a crossmember connected between a rear portion of the first half-frame body and a rear portion of the second half-frame body;
a rear wheel operatively connected to at least one of the front frame structure and the rear frame structure; and
a motor operatively connected to at least one of the front wheel and the rear wheel,
the crossmember having mounting points for selectively connecting a plurality of vehicle components, the plurality of vehicle components including at least two of:
a driver seat,
a passenger seat,
a rear fender,
a seat cowl, and
a taillight.

2. The motorcycle of claim 1, further comprising at least one of the driver seat and the passenger seat supported by the rear frame structure.

3. The motorcycle of claim 1, wherein the first half-frame body and the second half-frame body are welded space frames.

4. The motorcycle of claim 1, wherein:
the first half-frame body and the second half-frame body are formed from a first material; and
the crossmember is formed from a second material different from the first material.

5. The motorcycle of claim 1, wherein the crossmember is formed from a flexible material.

6. The motorcycle of claim 1, wherein the crossmember is formed from a molded material.

7. The motorcycle of claim 1, wherein the crossmember is formed from a polymer material.

8. The motorcycle of claim 1, wherein the crossmember is positioned and arranged to form a structural connection between the first and second half-frame bodies.

9. The motorcycle of claim 1, wherein the crossmember is further configured to selectively receive at least one of:
at least one passenger seat handle,
at least one saddle bag, and
a top case.

10. The motorcycle of claim 1, wherein:
the motorcycle is an electric motorcycle comprising a battery pack; and
the front frame structure is a battery housing of the battery pack.

11. The electric motorcycle of claim 10, further comprising a swingarm connected to at least one of the front frame structure and the rear frame structure; and
wherein the rear wheel is operatively connected to the swingarm.

12. The electric motorcycle of claim 11, further comprising an electric motor mounted on the swingarm, the electric motor being electrically connected to the battery pack, the electric motor being operatively connected to the rear wheel for driving the rear wheel during use.

13. A frame assembly for a motorcycle, the frame assembly comprising:
a front frame structure; and
a rear frame structure comprising:
a first half-frame body connected to the front frame structure;
a second half-frame body connected to the front frame structure, the second half-frame body being laterally spaced from the first half-frame body; and
a multifunction crossmember connected between a rear portion of the first half-frame and a rear portion of the second half-frame;
the multifunction crossmember having mounting points for selectively connecting a plurality of vehicle components, the plurality of vehicle components including at least two of:
a driver seat,
a passenger seat,
a rear fender,
a seat cowl, and
a taillight.

14. The frame assembly of claim 13, wherein the first half-frame body and the second half-frame body are welded space frames.

15. The frame assembly of claim 13, wherein:
the first half-frame body and the second half-frame body are formed from a first material; and
the crossmember is formed from a second material different from the first material.

16. The frame assembly of claim 13, wherein the crossmember is formed from a flexible material.

17. The frame assembly of claim 13, wherein the crossmember is formed from a molded material.

18. The frame assembly of claim 13, wherein the crossmember is formed from a polymer material.

19. The frame assembly of claim 13, wherein the crossmember is positioned and arranged to form a structural connection between the first and second half-frame bodies.

20. The frame assembly of claim 13, wherein the crossmember is further configured to selectively receive at least one of:
at least one passenger seat handle,
at least one saddle bag, and
a top case.
